(19) United States
(12) Patent Application Publication
(10) Pub. No.: US 2018/0053430 A1
(43) Pub. Date: Feb. 22, 2018

(54) METHOD FOR TRAINING AND DEVELOPMENT OF CRAFT SKILLS

(71) Applicant: Society of Cable Telecommunications Engineers, Inc., Exton, PA (US)

(72) Inventors: Mark Louis Dzuban, Elverson, PA (US); Renata Erika Gorman, Doylestown, PA (US)

(21) Appl. No.: 15/681,569

(22) Filed: Aug. 21, 2017

Related U.S. Application Data
(60) Provisional application No. 62/377,639, filed on Aug. 21, 2016.

(51) Int. Cl. G09B 5/06; G09B 21/00

(52) U.S. Cl. CPC G09B 5/06; G09B 7/04; G09B 21/009

(57) ABSTRACT

A method of learning is provided that is dedicated to advancing the expertise of participants in a workforce by utilizing advanced cognitive processes that deepen mastery of complex subject matter. The method is designed to deliver brain-based, customized learning activities that utilize multiple senses and educational touch points. The method dynamically learns, recommends and tracks individual learning progress, and recommends the best learning opportunities for each individual to deepen their knowledge and develop true expertise. The method provides ongoing customized educational opportunities, delivered and measured over time, resulting in a continuously improving workforce that can achieve higher levels of performance and make a significant contribution to realize operational excellence.

### CROSS REFERENCE TO RELATED APPLICATION

The present application claims the benefit of the filing date of U.S. Provisional Application No. 62/377,639, filed Aug. 21, 2016.

### BACKGROUND OF THE INVENTION

### Field of the Invention

The present invention relates to the continuous learning and development of an given workforce, in an industry, that is categorized with needing skilled workers with in depth knowledge to create expert high performers who deliver measurable business results. The platform delivers customized, personalized, and optimized learning activities over time that stimulate multiple areas of the brain to build up complex webs of knowledge, as the individual develops deep expertise.

### Related Art

The focus of most learning and development internal support functions is to teach people how to do their jobs. The goal is to get them trained as fast as possible and get them out the door to start producing. Because of this, the learning and development departments and systems are all geared toward delivering as little training as possible and still getting employees up and running/operating in their jobs. Yet in many industries, especially in complex ones such as in information technology, every job role has to have a complex level of expertise to do the job well (example: IT helpdesk).

### BRIEF SUMMARY OF THE INVENTION

The present invention is defined as an expert development (learning) system or method. The method is a new and innovative learning platform that delivers various types of learning content and experiences over time, to maximize the neurological learning process that occurs in the brain. The result takes a learner beyond the superficial learning of a subject, to the development of an extensive and deep neurological network of knowledge—research has proven that experts have complex webs of knowledge that they continuously access many facets of as they perform in their various fields of expertise. Being an expert in applied science by definition means a person is a high performer, therefore, to achieve maximum organizational performance, and ultimately achieve business results, workers have to develop expertise that goes deep beyond the surface.

Further features and advantages of the invention, as well as the structure and operation of various embodiments of the invention, are described in detail below with reference to the accompanying drawings. It is noted that the invention is not limited to the specific embodiments described herein. Such embodiments are presented herein tom illustrative purposes only. Additional embodiments will be apparent to persons skilled in the relevant art(s) based on the teachings contained herein.

### DESCRIPTION OF THE FIGURES

FIG. 1 shows an outline of the reasons for the contemplated method.

FIG. 2 shows a representation of brain activity as a result of the contemplated method.

FIG. 3 shows a representation of the drivers for the learning process according to Bloom's Taxonomy.

FIG. 4 shows a listing of verbs that are used within Bloom's Taxonomy to drive the learning activities.

FIG. 5 shows a series of performance goals related to the learning activities.

FIG. 6 shows enabling objectives in relation to a learning activity.

FIG. 7 shows a relationship between learning activity performance and team performance.

FIG. 8 shows a relationship between learning activity performance and company performance.

FIG. 9 shows an example of the flow of learning activities for participants.

FIG. 10 shows a relationship between further learning activity performance and learning goals.

FIG. 11 shows the implementation of the Kilpatrick Measurement Strategy within the contemplated method.

FIG. 12 shows a method of measurement for participant performance.

FIG. 13 shows a further learning activities within the contemplated method.

FIG. 14 shows a summary of the learning needs that are addressed by the learning activities of the contemplated method.

FIG. 15 shows a summary of learning moments within the contemplated method.

### DETAILED DESCRIPTION

The present invention will be described with reference to the accompanying figures, wherein like elements are the same when used in similar context across the figures.

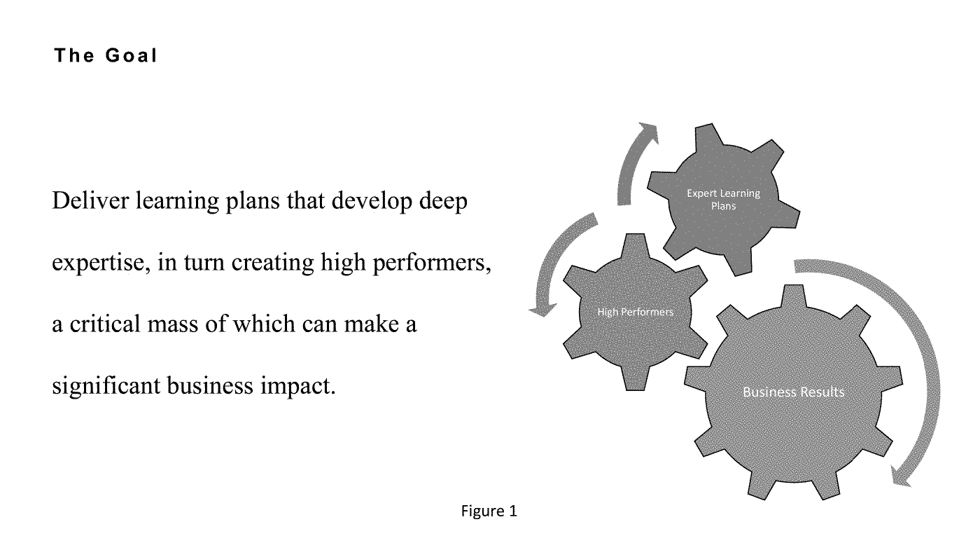

FIG. 1 illustrates the overall goal of this invention: To deliver learning plans that develop deep expertise, in turn creating high performers, a critical mass of which can make a significant business impact. Expert-driven learning plans continuously adapt to deliver the highest rated learning activities. These expert driven learning plans recommend activities based on what other successful people have done and found useful—which means the method is always learning and adapting—benefitting from social learning and crowdsourcing to ensure the “right” learning activities: timely, clear and covers what experts would want you to know are always being highlighted.

The method combines interactive opportunities into a holistic platform that tracks, recommends and adapts based on what other successful people completed and rated as most useful to develop expertise. The method is designed to continue fine tuning or even changing recommendations as experts continue to use it. It learns and automatically adjusts the algorithm it uses to make recommendations. Therefore the method uses crowd sourcing to identify the best learning activities, and eventually the best expert contributors.

Experts are high performers, in fact research shows that experts have many patterns in their brain associated with their area of expertise, they have experienced so many situations in their field that they've built up extensive webs of knowledge. Most experts developed their expertise as they worked, learning more as they progressed—somewhat accidentally. The expert development method guides learners giving them the opportunity to speed up then development, perform better and faster the more they interact with the method, ultimately advance their careers, and in a critical mass make an impact on their organization's business.

All learning experiences be they events or content must have dynamic meta data that calculates and stores the average rating on a 5 star scale. All learning activity stream data is stored that tells what each learner did and when in the process of their learning. Content recommended by the learners who achieve 100 points with the least amount of attempts is weighted more to make sure their recommendations float to the top.

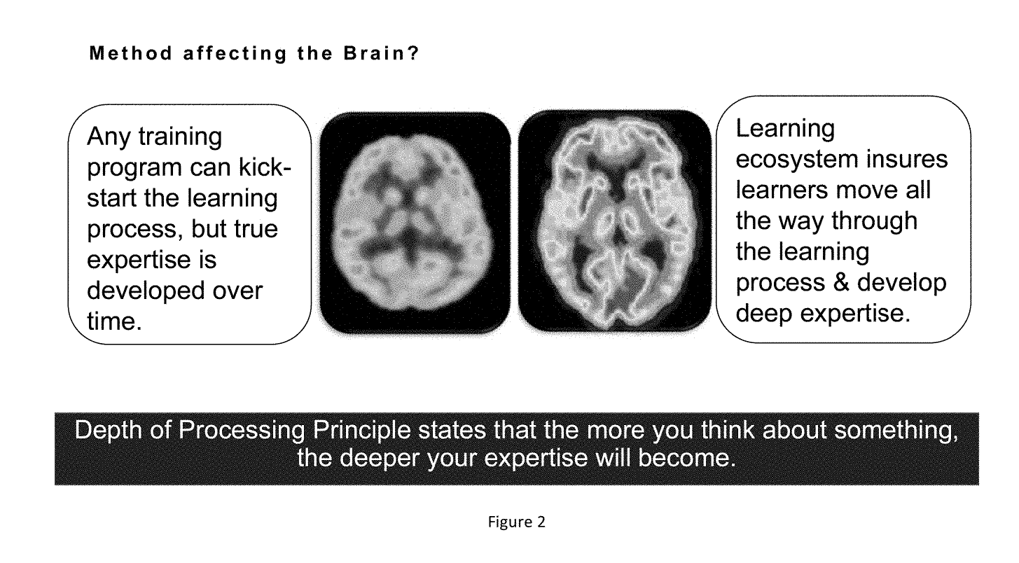

Referring to FIG. 2, the learning activities are sequenced in accordance with the neurological learning process. The expert driven learning plans recommend activities, sequenced to be conducive for the learning process and take learners from beginner, past simply performing, to performing like an expert.

Research shows that experts have a vast web of knowledge in their brains that needs many stimulated neurons, activated and added to continuously over time. Experts would be the first ones to say they never stop learning. The learning method stimulates the learners' neurons by delivering expert recommended activities sequenced in accordance with the neurological learning process. Learning is the process by which a learner takes information into the brain, processes it in short term memory, and then stores it in long term memory with enough effectiveness and strength of neurological connections that the learner can recall and use this knowledge as a platform to analyze a variety of situations and determine what the appropriate actions are to take in each.

Learning activities that activate multiple neural connections result in better recall. The learning activities give learners as much context as possible. Learning on the job, in context—results in the strongest memories because new information is saved using all the context dues that are later used as recall triggers. All the senses can be used to help make and recall the memory the look of the job (a performer's vantagepoint) the smell of the equipment, the sound of the equipment the feeling of the job is it outside, is it up high? The expert development method strives to activate as many senses as possible to create the strongest, contextualized memories.

A 3D simulation or an in person session where learners get to touch and operate the equipment helps bring more of the context of the job, into the learning process. On the job training evaluations can also be added to the method to track if successful completion of training really does impact performance. However, important to note that what we actually experience and what we can imagine experiencing has the same impact in terms of neurological activation in the brain. So, stories/case studies/examples that experts contribute to the method, that enable people to imagine themselves on the job is equally powerful. That is why the method will solicit content from experts in the same manner.

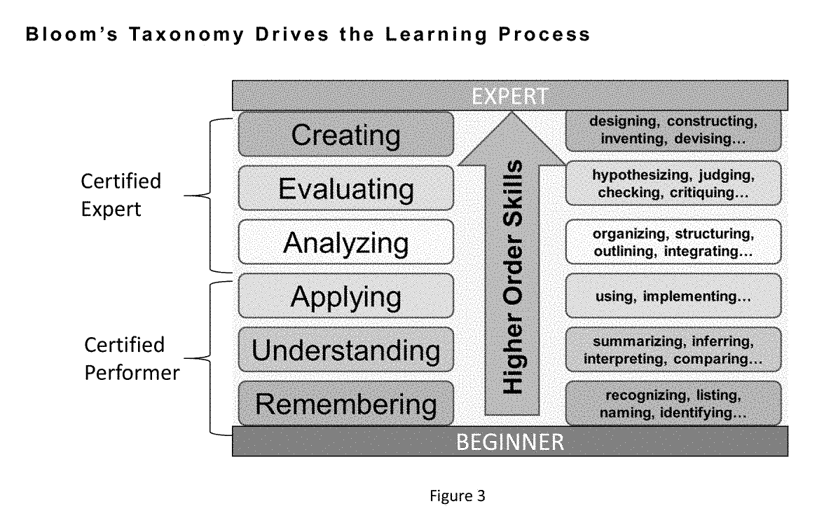

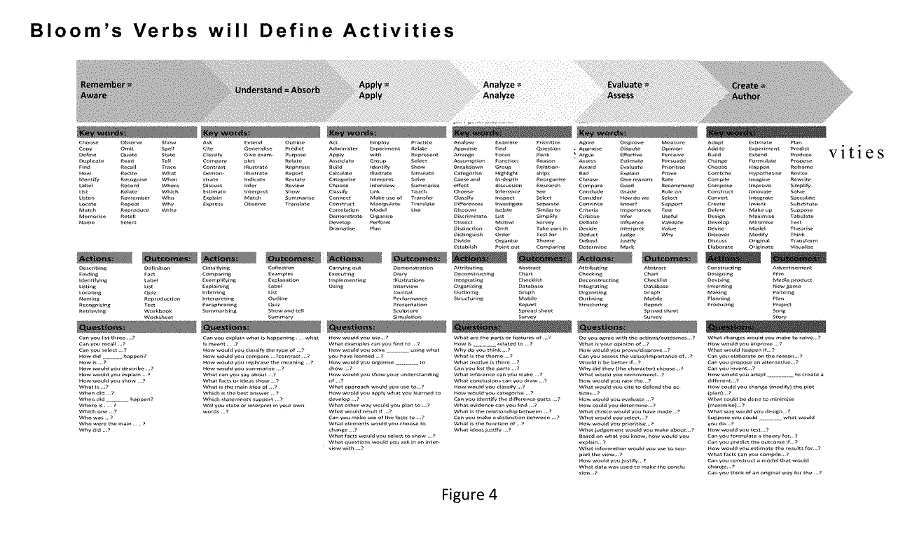

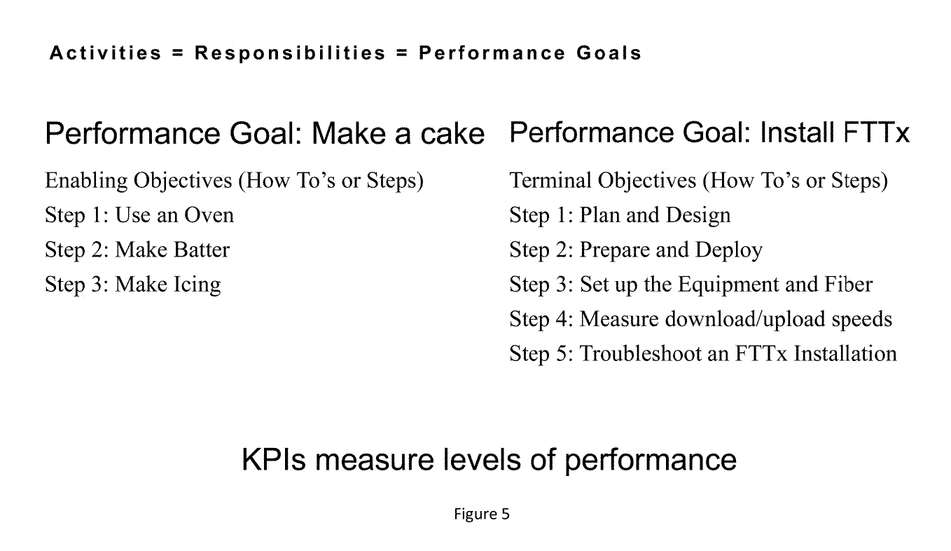

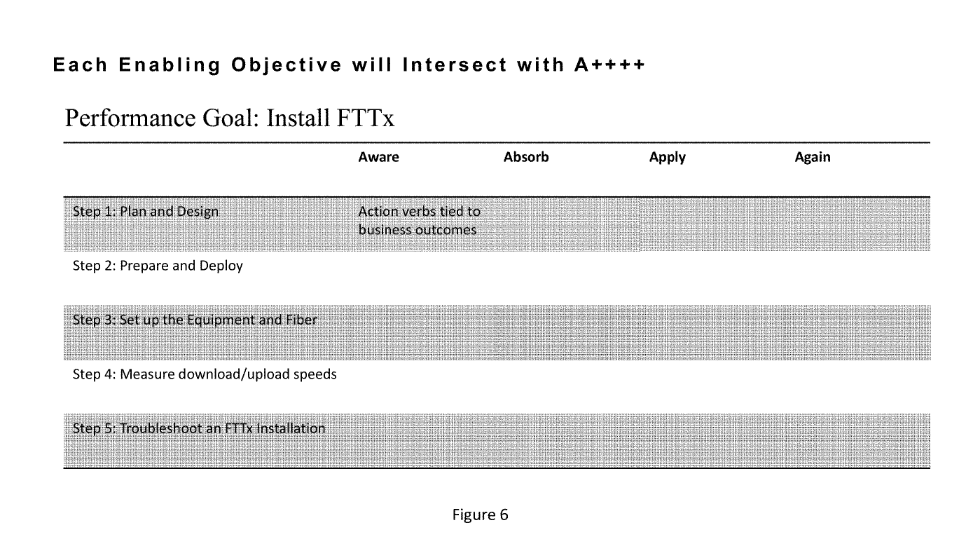

Referring to FIGS. 3, 4, 5, and 6, the method uses an augmented version of Bloom's Taxonomy that solves for the Forgetting Curve to insure maximum retention. The method augment's Bloom's Taxonomy and incorporates the lessons learned from Ebbinghaus' Forgetting Curve by adding elements to reinforce learnings. Individuals can be certified performers by learning on their own however to become a certified expert, learners have to give back to the community and help others learn. Bloom's taxonomy helps sequence the learning activities by providing learning goals from beginner to performer to expert. Bloom's taxonomy is a classification method, designed based on decades of research and used to define and distinguish different levels of human cognition—i.e. thinking, learning, and understanding. All learning activities are tagged with various meta data that describes that activity. This is important because later the rules engine will read this, meta data and use it to dynamically assemble learning plans. Each learning activity has the following meta data: which learning objectives it teaches for what topic, how many points can a learner achieve, and which learning level they relate to.

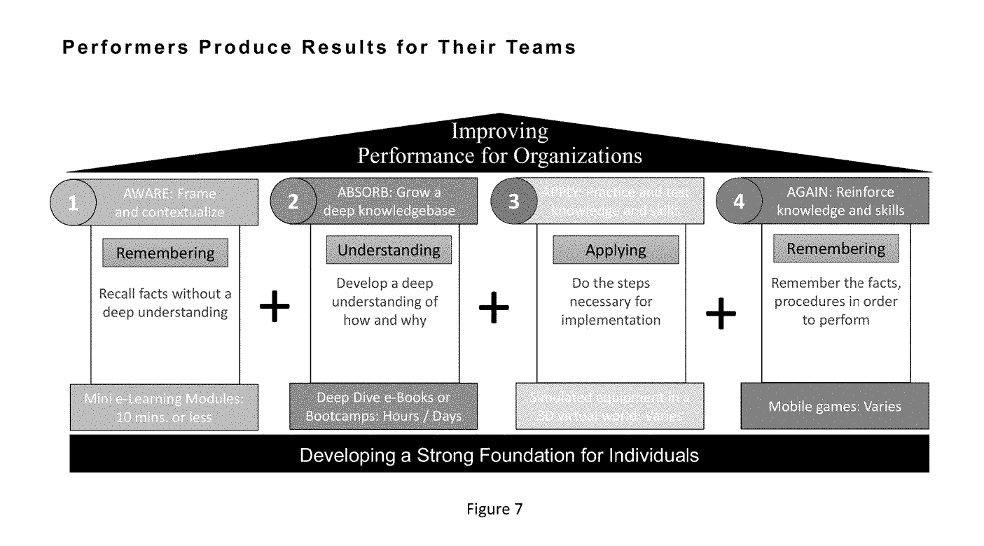

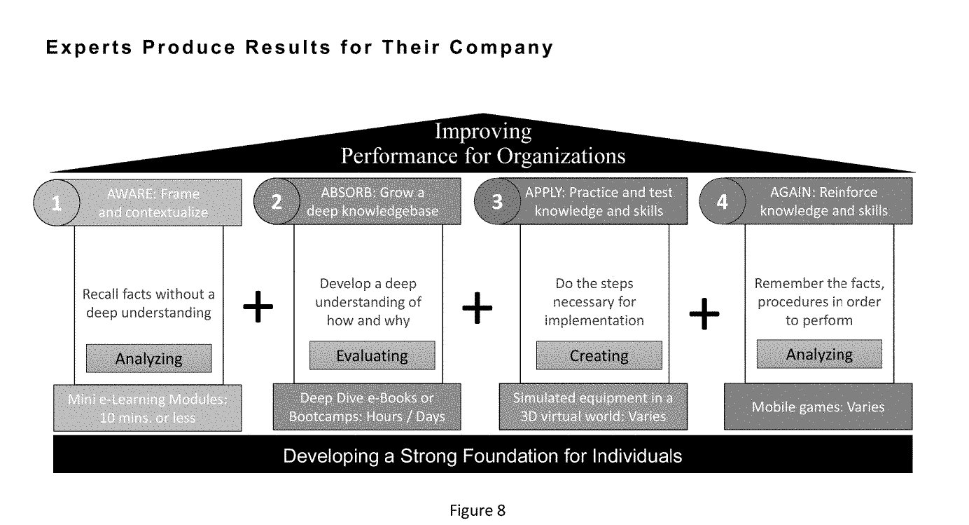

FIGS. 7 and 8 show that learning activities and content are developed using the A4 framework that is mapped to Bloom's taxonomy and augmented based on the forgetting curve. Each learning activity is tagged with the part of the learning process they we suited for because each have learning objectives that line up to a phase of learning. Phase of learning, topic, role (job function), and expert ratings are the primary drivers of delivery. Phase of learning and learning objectives speak to sequence.

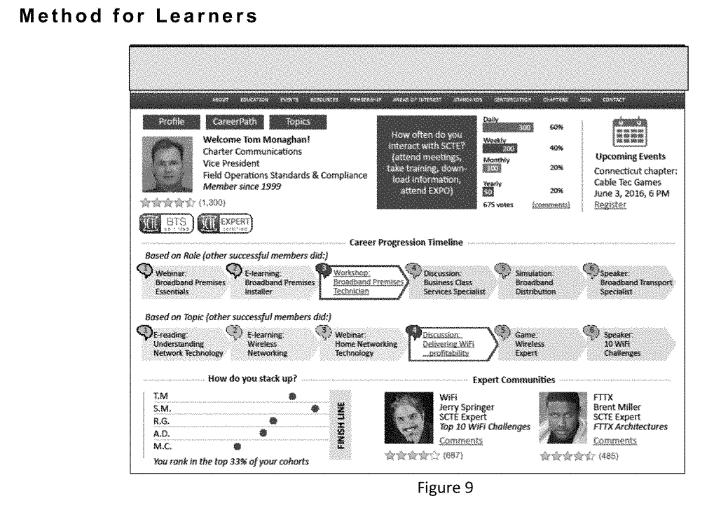

FIG. 9 shows role/function, topics of interest, to include leadership, are key inputs needed from learners. A generic career map that applies to an entire industry and has all the major functions and associated roles allows learners to set their career goals, and/or they can select topics they want to develop expertise in. They can also designate whether or not they are interested in leadership, in which case a 3^{rd} learning plan on leadership is visible which begins with a leadership personality assessment.

Adult learners want options, so the method allows substitution for learning activities. Over time several learning experiences could apply to each step in the learning process for a given topic. Learners are then able to replace recommendations with other learning activities that accomplish the same learning goals. The notion of equivalencies comes up when we consider that there could be several types of learning activities that all satisfy various learning objectives, though they may be rated differently. The method recommends at least the top 3 and allows learners to look even deeper if they wish.

The method observes learner preferences and makes recommendations accordingly. What each learner gravitates towards in terms of learning activity/content types becomes obvious, for example learners who prefer video versus a white paper, versus an in person class. Learner preferences will naturally reveal themselves. Learning activity substitutions have to be monitored/counted and if the learner replaces most white papers with video, the method will deliver and recommend the learning activity type that is closest to the preferences of learners, in this example, that would be video.

Pre-tests/quizzes allow learners to identify their knowledge gaps and focus on closing them. Adult learners want to be self-directed to drive their own learning activities, in addition focused, goal driven learning that covers that particular learner's knowledge gaps is ideal to minimize time, maximize learning effectiveness and create a personalized learning experience. As there are no gates in the method, learners can jump, in and out of learning activities as they wish. They can quiz out if they know the material already. Each quiz will give feedback to the learner on what knowledge gaps to focus on while they are going through the learning activity therefore it keeps the learning focused. When the brain has a goal, such as to find the answers to the missed quiz questions, learning and long term recall are much stronger because they are active learners versus passive with just a general goal of studying.

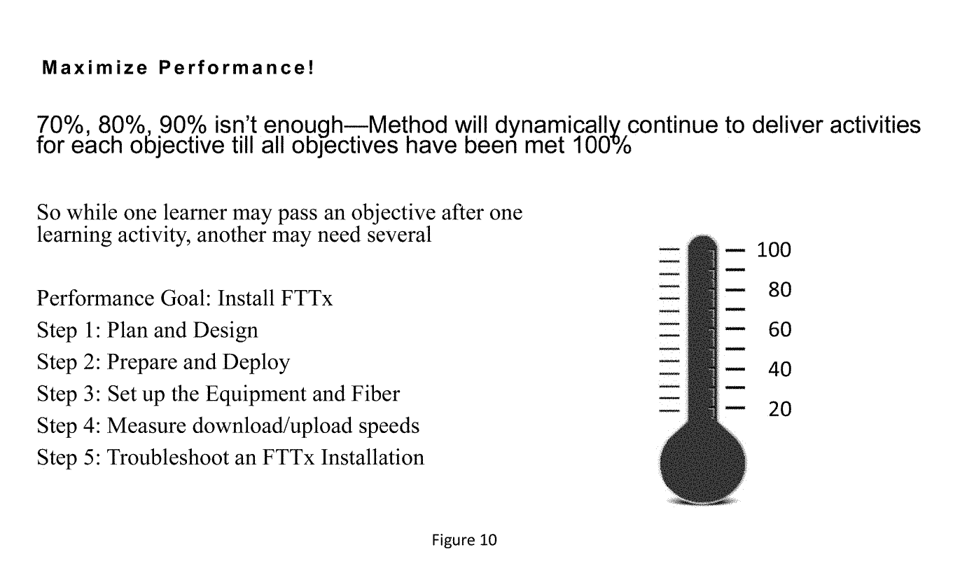

Referring to FIG. 10, scoring a 70%, 80% or 90% isn't good enough, as all knowledge, gaps should be filled for the learner to achieve 100%. In fact, the method certifies people who have learned enough to perform the job, however the passing score is 100 and the learner earns badges along the way to earning an industry certification. Each performance and learning objective has been deemed important by an expert, an organization that truly wants to achieve business results should ensure that each person learns each point. Therefore this learning method changes the old grading models into a point method. The method will continue to present the learner with learning activities until he/she gets the necessary 100 points. Positive reinforcement and tracking motivates leaners, therefore the method awards badges and certain badges collected equal a certification. This changes the old testing paradigm as well because learners can earn as they learn instead of waiting until the end and cramming for a large exam. Given learning is a process, testing should equally be a process over time.

Each activity will be assigned points based on the learning objectives the activity covers, Each learning objective will be given a set number of points; 1-10 as an example. Successfully completing a competency or learning objective results in a badge, gathering all badges needed for a certification earns that certification. Meta data used for tagging the learning activities includes fields for role and topic, learning objective, points needed to pass, badge and certification.

The method is not a typical training program of courses and catalogs; the method delivers and tracks any type of activity,

Examples of activity types: attending an event, watching a video, contributing to a threaded discussion, completing a module, completing a quiz, interacting with a 3D simulation, etc.

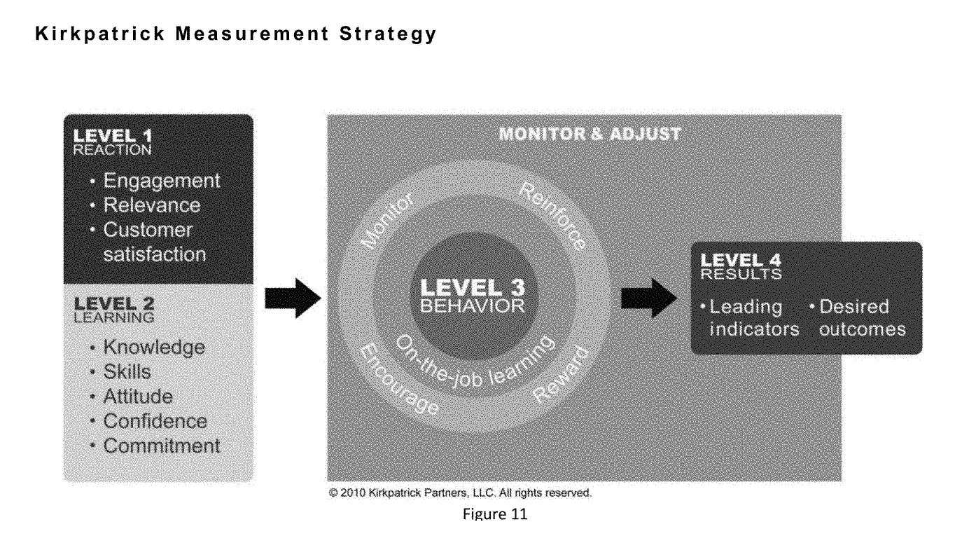

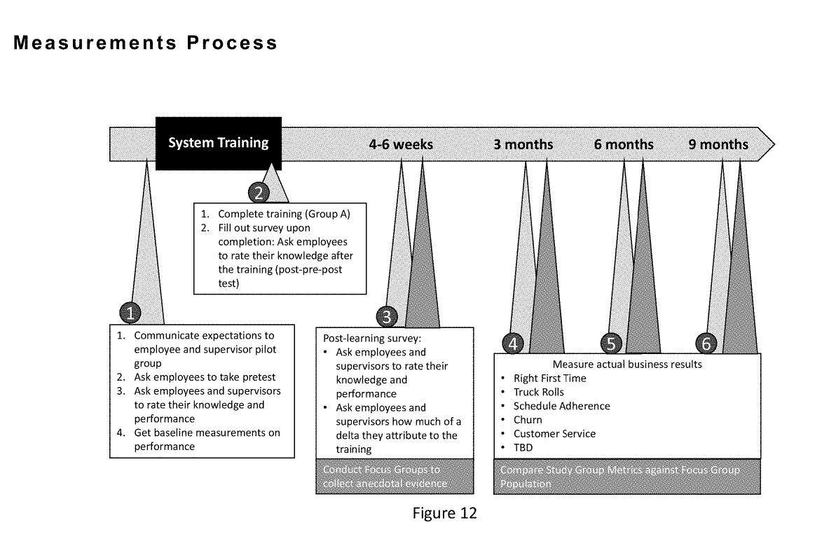

Referring to FIGS. 11 and 12, the client organization leaders cart track the progress of their organization's employees and connect learning to business results using the Kirkpatrick's measurement framework. The method has various automatic triggers for initiating a data gathering feedback loop. To satisfy Kirkpatrick's Level 1 assessment, all learning activities are rated by an overall satisfaction rating, while courses continue to have the end of course evaluation to get more robust feedback from learners.

Level 2 seeks to gather data about the effectiveness of the learning experiences. Learners have to take a quiz after each learning experience to ascertain whether or not they have achieved enough points to move onto the next learning experience, if not, the method continues to recommend learning experiences that meet the same learning objectives, until the learner achieves the maximum points needed to move on.

Level 3 of the measurement framework looks at on the job behavior and seeks to ascertain whether or not people are successfully performing their new skills, underscored by their new knowledge, on the job. Minimally, the method can automatically survey each learner's supervisor, to have them rate their employees on the job performance before and after the training. Ideally, the client organization can feed score card or key per indicator (KPI) data into the dashboard as well to see the hard numbers that represent on the job performance improvements.

Level 4 uncovers the impact of the learning to the business. Building on level 3, conclusions can be made to figure out how much the on the job performance improvements have contributed to the organization's overall business goals.

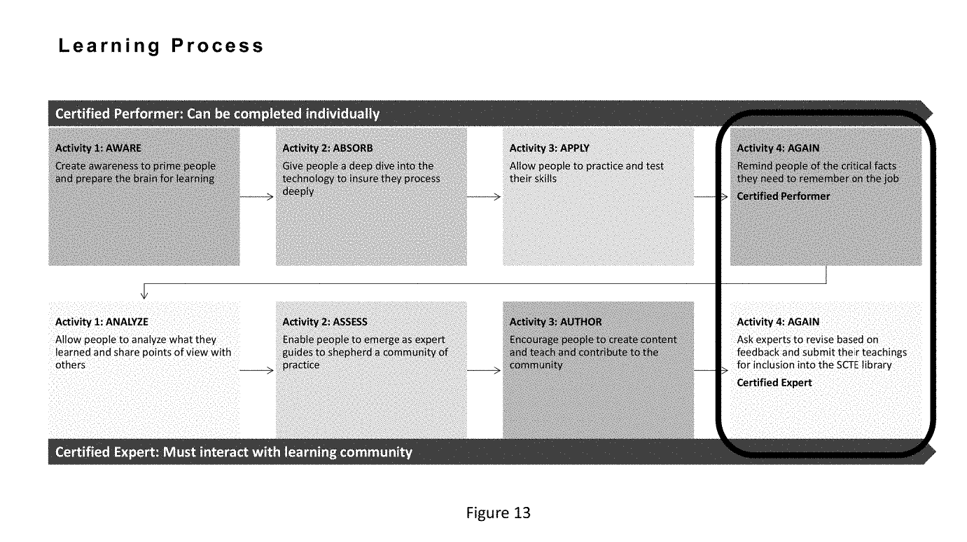

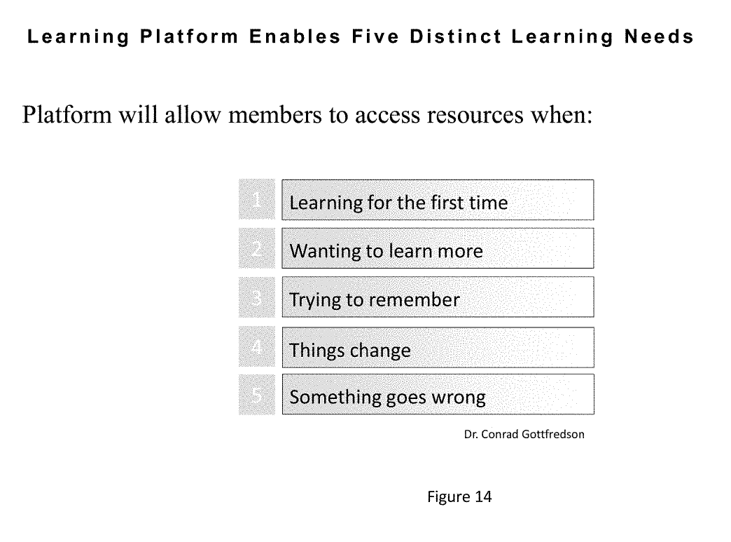

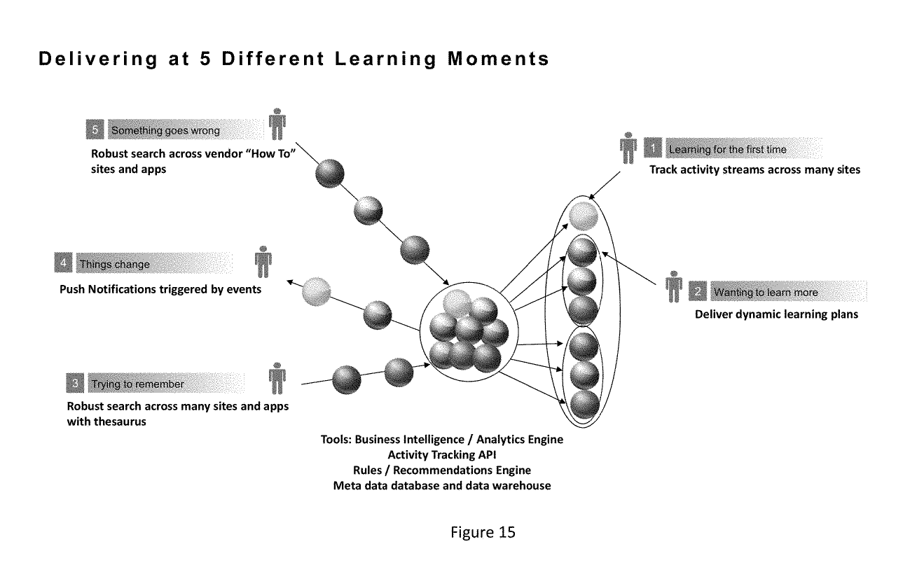

Referring to FIGS. 13, 14 and 15, the method is designed to deliver resources, during the five moments of learning needs. Learning for the first time requires building awareness and context mound a given topic, short bites of information can be utilized to satisfy this learning need. Pillar 1 of the A4 framework ensures that learning activities that answer key questions, create awareness and provide context are identified and tamed to satisfy this learning need. informal learning especially videos with subject matter experts fits perfectly here, as do mini modules targeted in Pillar 1.

Wanting to learn more usually leads learners towards taking deep dives into the content, this is when the learner digs into all the details; this type of content tends to be Pillar 2 of the A4 framework as it delivers very rich learning activities and content with a lot of depth; tends to be formal training.

Trying to remember (all the detailed learned in Pillar 2) can be difficult unless you can practice your skills. Actually doing what you have learned maximizes the neural connections that are created with all of your senses. Pillar 3 focuses on applying what you have learned and can take place in classroom sessions with hands on manipulation of the equipment or in a 3D environment. Trying to remember is also aligned with the A4 framework's pillar 4 that is intended to reinforce new learnings.

Things change speaks to keeping our learners up to date on the rapid changes in the industry and in turn in the learning associated. Learners are able to customize the notifications they receive.

Finally, something went wrong is a teaming need that necessitates excellent on the job tools and resources that quickly allow learners to diagnose a problem and fix it. How to information, such as equipment installation specifications, should be easily searchable on the job and retrievable.

Through the use of the method, experts become visible through the ratings they receive. As experts contribute to the learning process, their contributions are rated by others in the community. An organization could then use the reporting dashboard to find and connect with the experts in the organization, mobilize them to help move the needle on the business.

While various embodiments of the present invention have been described above, it should be understood that they have been presented by way of example only, and not limit limitation.

What is claimed is:

1. A method of learning and development for a workforce participants, comprising the steps of:
delivering a customized, personalized, and optimized learning activities over time
stimulating multiple parts of the brain to build up webs of knowledge, and
creating participants who are expert high performers and who deliver business results.

2. The method of claim 1, wherein the learning activities are sequenced accordance with a neurological learning process.

3. The method of claim 1, wherein learning activities create multiple neural connections and result in better recall.

4. The method of claim 1, wherein the learning activities comprises an augmented Bloom Taxonomy to develop, expertise and solves for a forgetting curve to insure maximum retention.

5. The method of claim 1, wherein learning activities are developed using an A4 framework that is mapped to a Bloom Taxonomy and augmented based on a forgetting curve.

6. The method of claim 1, wherein the learning activities allow for substitution of learning activities based on defined criteria.

7. The method of claim 1, wherein the learning activities are optimized to learner preferences of the participants, including audio codec settings for the hearing-impaired participants, and font settings for the sight-impaired participants.

8. The method of claim 1, wherein the learning activities are optimized to the specific environment preferences of the participants, such as specific equipment vendors used in their workplace, and renders the optimized preferences in a 3D environment.

9. The method of claim further comprising reporting dashboards that allow tine participants, including individuals and or to tie learning to results.

10. The method of claim 1, wherein the learning activities are designed to deliver resources during moments of learning needs that comprise
a. Learning for the first time
b. Wanting to learn more
c. Trying to remember
Things change, and
Something goes wrong

11. The method of claim 1, wherein high expert performing participants are identified through the ratings they receive from the learning activities.
